(19) United States
(12) Patent Application Publication
(10) Pub. No.: US 2024/0369863 A1
(43) Pub. Date: Nov. 7, 2024

(54) MICRO-RING RESONATOR AND ELECTRONIC DEVICE

(71) Applicant: SUZHOU DAWNING SEMI TECHNOLOGY CO., LTD., Suzhou (CN)

(72) Inventor: Yao WANG, Suzhou (CN)

(73) Assignee: SUZHOU DAWNING SEMI TECHNOLOGY CO., LTD., Suzhou (CN)

(21) Appl. No.: 18/572,859

(22) PCT Filed: Aug. 1, 2022
(86) PCT No.: PCT/CN2022/109388

§ 371 Date: Dec. 21, 2023

(30) Foreign Application Priority Data
Apr. 21, 2022 (CN) 202210418301.0

(51) Int. Cl. G02F 1/01; G02F 1/025

(52) U.S. Cl. CPC G02F 1/0147; G02F 1/025

(57) ABSTRACT

Provided are a micro-ring resonator and an electronic device. The micro-ring resonator includes a multi-mode straight waveguide and a micro-ring waveguide, and the micro-ring waveguide and the multi-mode straight waveguide are in a coupling relationship with each other; the multi-mode straight waveguide and the micro-ring waveguide have a coupling region; a portion of the multi-mode straight waveguide disposed in the coupling region is configured to transmit at least two optical signals so that the transmission spectrum of the micro-ring resonator is a Fano resonance line-shape transmission spectrum.

The present application claims priority to Chinese Patent Application No. 202210418301.0 filed Apr. 21, 2022, the disclosure of which is incorporated herein by reference in its entirety.

### TECHNICAL FIELD

The present application relates to the technical field of optoelectronic devices, for example, a micro-ring resonator and an electronic device.

### BACKGROUND

A micro-ring resonator, one of the basic components of an optoelectronic integrated chip, is generally composed of a micro-ring waveguide and a single-mode straight waveguide coupled on one side. The micro-ring resonator may be applied to fields such as filters, sensors, modulators, and switches.

The micro-ring resonator in related art is a Lorentz-resonance micro-ring resonator whose transmission spectral line is a periodic symmetrical sunken resonance valley. Compared with the symmetric Lorentz line-shape, the asymmetric Fano resonance line-shape has better characteristics, the transmission coefficient of the spectral line changes in a wider range, and the change trend is sharper. These excellent characteristics make Fano-type resonators have more advantages in fields such as optical switches with a high on/off ratio, modulators with a high modulation depth, filters with a narrow band, and biochemical sensors with high sensitivity.

### SUMMARY

The present application provides a micro-ring resonator and an electronic device, which can achieve a micro-ring resonator with a Fano resonance line-shape transmission spectrum.

In one aspect, an embodiment of the present application provides a micro-ring resonator. The micro-ring resonator includes a multi-mode straight waveguide and a micro-ring waveguide. The micro-ring waveguide and the multi-mode straight waveguide are in a coupling relationship with each other. The multi-mode straight waveguide and the micro-ring waveguide have a coupling region. A portion of the multi-mode straight waveguide disposed in the coupling region is configured to transmit at least two optical signals so that the transmission spectrum of the micro-ring resonator is a Fano resonance line-shape transmission spectrum.

In another aspect, an embodiment provides an electronic device. The device includes the preceding micro-ring resonator and any one of a filter, a sensor, a modulator, and an optical switch.

### BRIEF DESCRIPTION OF DRAWINGS

FIG. 1 is a top view of a micro-ring resonator according to an embodiment of the present application.

FIG. 2 is a top view of another micro-ring resonator according to an embodiment of the present application.

FIG. 3 is a sectional view illustrating the structure taken in the direction of A1-A2 in FIG. 2.

FIG. 4 is a top view of another micro-ring resonator according to an embodiment of the present application.

FIG. 5 is a sectional view illustrating the structure taken in the direction of A1-A2 in FIG. 4.

FIG. 6 is a top view of another micro-ring resonator according to an embodiment of the present application.

FIG. 7 is a sectional view illustrating the structure taken in the direction of A1-A2 in FIG. 6.

FIG. 8 is a top view of another micro-ring resonator according to an embodiment of the present application.

FIG. 9 is a sectional view illustrating the structure taken in the direction of A1-A2 in FIG. 8.

FIG. 10 is a schematic diagram illustrating that the micro-ring resonator transmits optical signals shown in FIG. 2.

FIG. 11 is a schematic diagram illustrating that the micro-ring resonator transmits optical signals shown in FIG. 6.

FIG. 12 is a schematic diagram illustrating that the micro-ring resonator transmits optical signals shown in FIG. 8.

FIG. 13 is a schematic diagram illustrating that optical signals are transmitted in a multi-mode transmission region according to an embodiment of the present application.

FIG. 14 is a transmission spectrum of a micro-ring resonator according to an embodiment of the present application.

FIG. 15 is a transmission spectrum of another micro-ring resonator according to an embodiment of the present application.

FIG. 16 is a transmission spectrum of another micro-ring resonator according to an embodiment of the present application.

FIG. 17 is a transmission spectrum of another micro-ring resonator according to an embodiment of the present application.

FIG. 18 is a transmission spectrum of another micro-ring resonator according to an embodiment of the present application.

FIG. 19 is a transmission spectrum of another micro-ring resonator according to an embodiment of the present application.

FIG. 20 is a top view of another micro-ring resonator according to an embodiment of the present application.

FIG. 21 is a sectional view illustrating the structure taken in the direction of A1-A2 in FIG. 20.

FIG. 22 is a top view of another micro-ring resonator according to an embodiment of the present application.

FIG. 23 is a sectional view illustrating the structure taken in the direction of A1-A2 in FIG. 22.

FIG. 24 is a top view of another micro-ring resonator according to an embodiment of the present application.

FIG. 25 is a sectional view illustrating the structure taken in the direction of A1-A2 in FIG. 24.

### DETAILED DESCRIPTION

It is to be noted that terms such as “first” and “second” in the description, claims, and drawings of the present application are used to distinguish between similar objects and are not necessarily used to describe a particular order or sequence. It should be understood that the data used in this manner is interchangeable where appropriate so that the embodiments of the present application described herein may also be implemented in a sequence not illustrated or described herein. Additionally, terms “comprising”, “including”, and any other variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

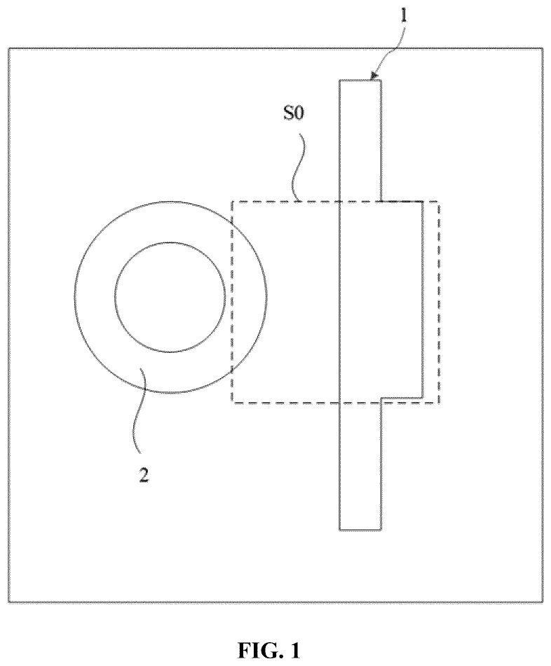

An embodiment of the present application provides a micro-ring resonator. FIG. 1 is a top view of a micro-ring resonator according to an embodiment of the present application. With reference to FIG. 1, the micro-ring resonator includes a multi-mode straight waveguide 1 and a micro-ring waveguide 2; the micro-ring waveguide 2 and the multi-mode straight waveguide 1 are in a coupling relationship with each other; the multi-mode straight waveguide 1 and the micro-ring waveguide 2 have a coupling region S0; a portion of the multi-mode straight waveguide 1 disposed in the coupling region S0 is configured to transmit at least two optical signals so that the transmission spectrum of the micro-ring resonator is a Fano resonance line-shape transmission spectrum.

In an embodiment, the portion of the multi-mode straight waveguide 1 disposed in the coupling region S0 includes but is not limited to the shape of FIG. 1.

According to the technical solution provided by this embodiment, the portion of the multi-mode straight waveguide 1 disposed in the coupling region may divide an optical signal into at least two optical signals so that mode competition occurs in the optical signals in the coupling region. Different multi-mode interference conditions are obtained by the control of the characteristic dimensions of the portion of the multi-mode straight waveguide 1 disposed in the coupling region, such as the length and width. Different multi-mode interference conditions result in different coupling conditions between the multi-mode straight waveguide 1 and the micro-ring waveguide 2. Thus, the transmission spectrum of the micro-ring resonator can be controlled to form a Fano resonance line-shape transmission spectrum, making the micro-ring resonator a Fano-type micro-ring resonator. Moreover, the principle of the micro-ring resonator provided by embodiments of the present application is different from that of the Fano-type micro-ring resonator formed in a manner where, for example, a grating reflection structure and air holes are formed in a single-mode straight waveguide. The Fano-type micro-ring resonator formed in a manner where, for example, a grating reflection structure and air holes are formed in a single-mode straight waveguide in the related art is formed by the formation of a Fabry-Perot resonant cavity or a Bragg grating reflection-type structure in the single-mode straight waveguide. In this embodiment, the portion of the multi-mode straight waveguide disposed in the coupling region may be widened and lengthened. It is in no need to form, for example, a grating reflection structure and air holes in the single-mode straight waveguide by etching a small-sized single-mode straight waveguide to form a micro-ring resonator with a Fano resonance line-shape transmission spectrum, which simplifies the preparation technique and reduces the cost. Thus, it is suitable for large-scale production.

In an embodiment, the multi-mode straight waveguide 1 includes a single-mode input terminal, a multi-mode transmission region, and a single-mode output terminal; the micro-ring waveguide 2 and the multi-mode straight waveguide 1 are in a coupling relationship with each other; the multi-mode transmission region is disposed in the coupling region of the multi-mode straight waveguide 1 and the micro-ring waveguide 2 and the multi-mode transmission region includes a straight waveguide transmission portion and a side waveguide transmission portion connected to each other, the straight waveguide transmission portion is disposed on the same straight line as the single-mode input terminal and the single-mode output terminal, and the side waveguide transmission portion is disposed at at least one side of the straight waveguide transmission portion.

In an embodiment, the micro-ring waveguide includes a circular micro-ring waveguide or an elliptical micro-ring waveguide. In this embodiment, a circular micro-ring waveguide is used as an example for introduction.

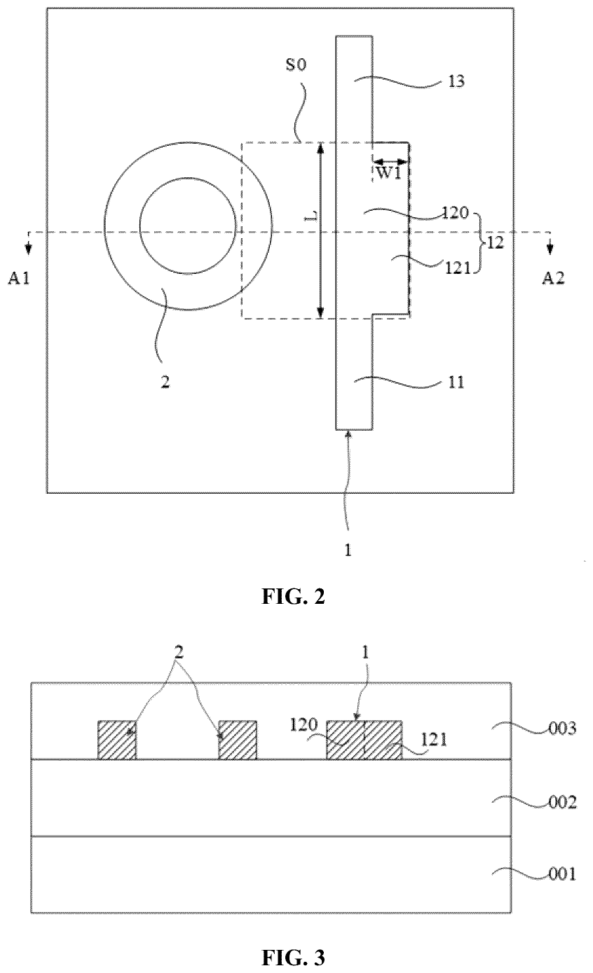

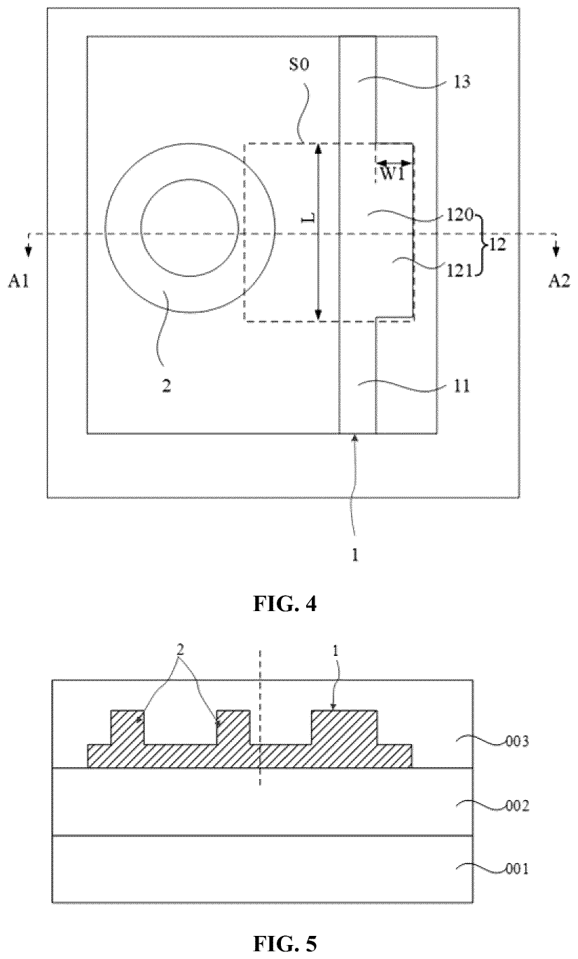

In an embodiment, the micro-ring waveguide 2 and the multi-mode straight waveguide 1 are in a horizontal coupling relationship or a vertical coupling relationship with each other. FIG. 2 is a top view of another micro-ring resonator according to an embodiment of the present application. FIG. 3 is a sectional view illustrating the structure taken in the direction of A1-A2 in FIG. 2. In an embodiment, FIGS. 2 and 3 and FIGS. 4 and 5 show that the micro-ring waveguide 2 and the multi-mode straight waveguide 1 are in a horizontal coupling relationship with each other. The gap between the micro-ring waveguide 2 and the multi-mode straight waveguide 1 in the horizontal direction is g. It should be noted that the multi-mode straight waveguide 1 may be an ordinary straight waveguide shown in FIGS. 2 and 3 or a ridge waveguide shown in FIGS. 4 and 5. It should be noted that when the micro-ring waveguide 2 and the multi-mode straight waveguide 1 are in a vertical coupling relationship with each other, the micro-ring waveguide is disposed above the multi-mode straight waveguide, and the distance between the micro-ring waveguide and the multi-mode straight waveguide in the vertical direction is the coupling gap g.

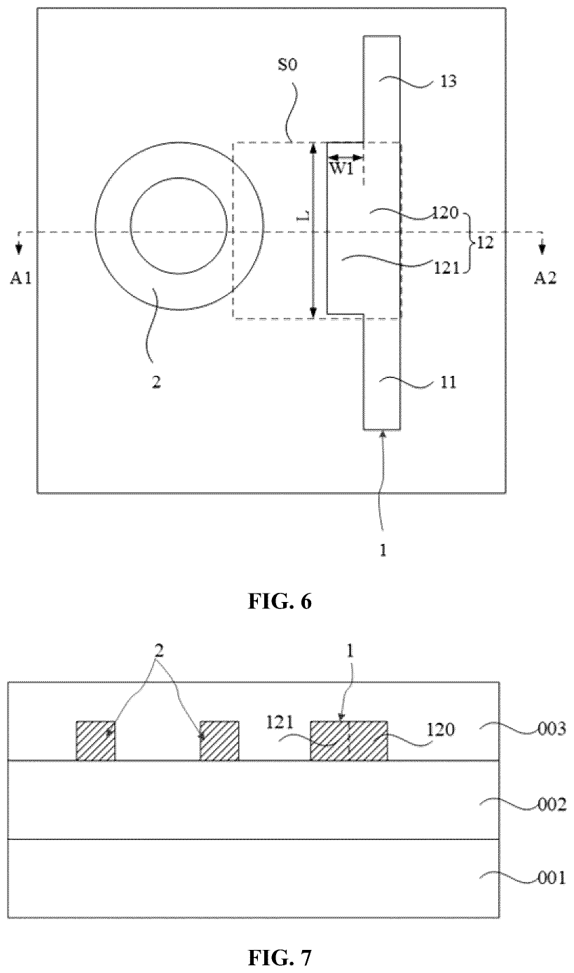

In an embodiment, with reference to FIGS. 2, 4, 6, and 8, the micro-ring resonator includes a multi-mode straight waveguide 1 and a micro-ring waveguide 2; the multi-mode straight waveguide 1 includes a single-mode input terminal 11, a multi-mode transmission region 12, and a single-mode output terminal 13; the micro-ring waveguide 2 is disposed at one side of the multi-mode straight waveguide 1, and the micro-ring waveguide 2 and the multi-mode straight waveguide 1 are in a horizontal coupling relationship with each other; the multi-mode transmission region 12 is disposed in the coupling region S0 of the multi-mode straight waveguide 1 and the micro-ring waveguide 2. Moreover, the multi-mode transmission region 12 includes a straight waveguide transmission portion 120 and a side waveguide transmission portion 121 connected to each other, the straight waveguide transmission portion 120 is disposed on the same straight line as the single-mode input terminal 11 and the single-mode output terminal 13, and the side waveguide transmission portion 121 is disposed at at least one side of the straight waveguide transmission portion 120. FIGS. 3, 5, 7, and 9 are sectional views illustrating the structures corresponding to FIGS. 2, 4, 6, and 8, respectively.

The thickness and width of the multi-mode straight waveguide 1 is within a predetermined range, the thickness and width of the micro-ring waveguide 2 is within a predetermined range and the coupling gap g between the multi-mode straight waveguide 1 and the micro-ring waveguide 2 is within a predetermined range. The multi-mode straight waveguide 1 and the micro-ring waveguide 2 have a coupling region S0 for optical signals. In an embodiment, the thickness of the micro-ring waveguide 2 is about 220 nm, and the width of the micro-ring waveguide 2 is about 450 nm. The coupling gap g between the multi-mode straight waveguide 1 and the micro-ring waveguide 2 is about 200 nm. The radius of the micro-ring waveguide 2 is within a predetermined range. In FIGS. 2 and 3, the thickness of the multi-mode straight waveguide 1 is about 220 nm, while for the ridged multi-mode straight waveguides in FIGS. 4 and 5, the height of the ridge waveguide is 130 nm, and the portion of the plane waveguide has a height of 90 nm. The width of the ridge waveguide is about 450 nm. The multi-mode straight waveguide 1 and the micro-ring waveguide 2 have a higher refractive index than the substrate and cladding materials so that optical signals can be trapped in the waveguide without entering the cladding. In an embodiment, the waveguide is made of Silicon-on-insulator (SOI) on an insulated substrate; a substrate 001 is made of silicon material, an inner cladding layer 002 is made of silicon dioxide, the multi-mode straight waveguide 1 and the micro-ring waveguide 2 are made of silicon material, and an outer cladding 003 is made of silicon dioxide. This structure provided by the present application is compatible with the materials and techniques for preparing photonic devices in related technologies in terms of material selection and preparation techniques. It should be noted that in the top view of the micro-ring resonator according to this embodiment of the present application, the outer cladding layer 003 is not shown so that it is easier to show the relative positional relationship between the multi-mode straight waveguide 1 and the micro-ring waveguide 2 in the top view.

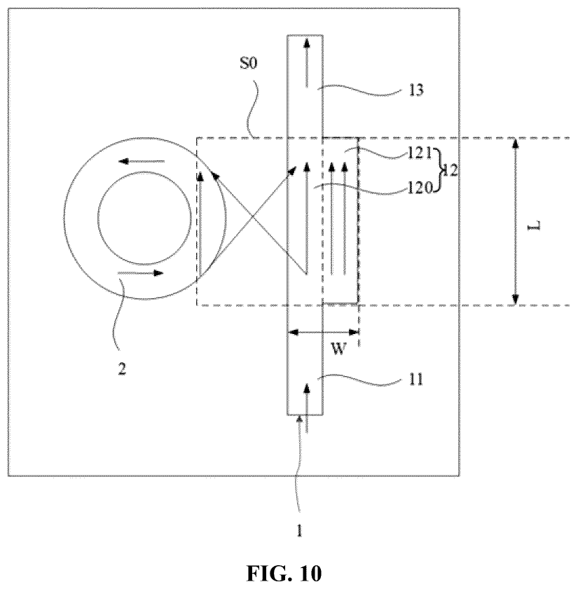

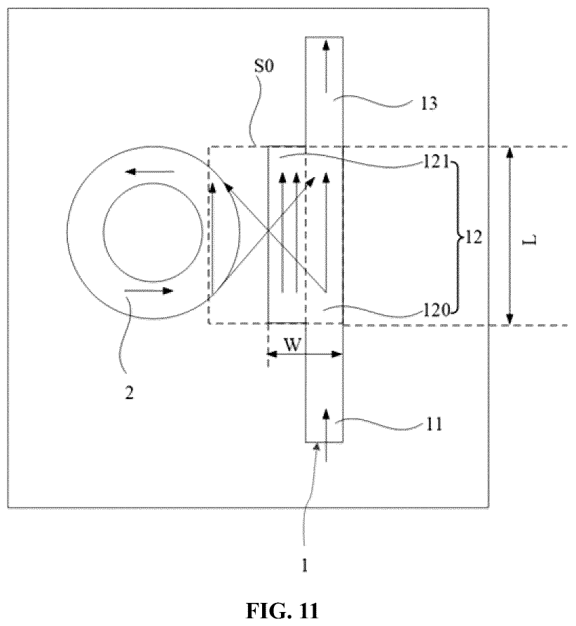

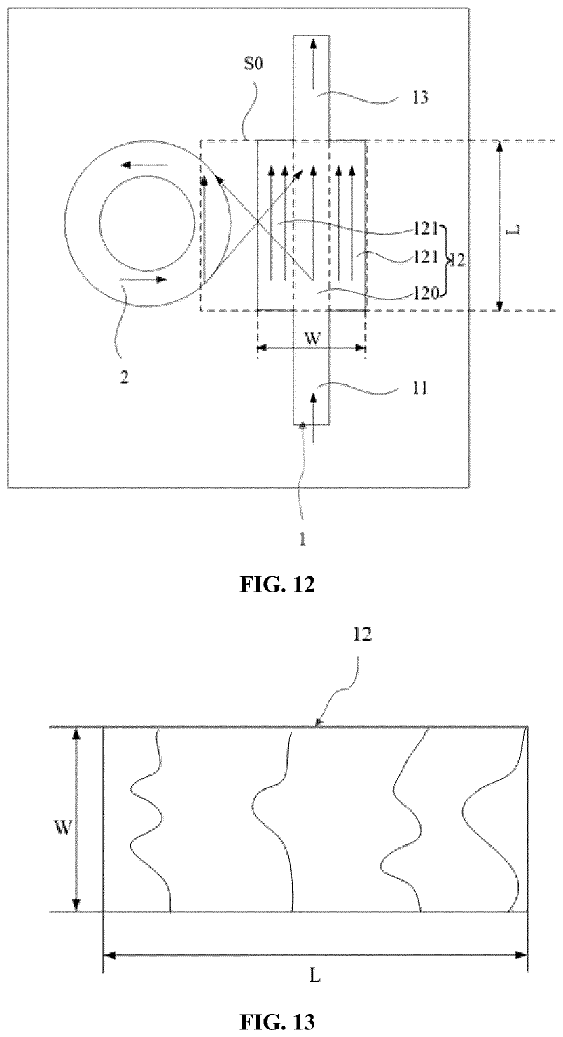

With reference to FIGS. 10 to 12, in this embodiment, an optical signal is transmitted to the multi-mode transmission region 12 through the single-mode input terminal 11 of the multi-mode straight waveguide 1; the light in the multi-mode straight waveguide 1 is divided into two parts, a small part of the light is coupled into the micro-ring waveguide 2 through the evanescent field and is in a resonance state, and most of the light is output from the single-mode output terminal 13 directly through the multi-mode straight waveguide 1. The light coupled into the micro-ring waveguide 2 travels for one cycle, returns to the coupling region S0, and interferes with the optical signal newly coupled into the ring. Since the multi-mode straight waveguide 1 includes a multi-mode transmission region 12 disposed in the coupling region S0, and the multi-mode transmission region 12 includes a straight waveguide transmission portion 120 and a side waveguide transmission portion 121, optical signals transmitted in the multi-mode transmission region 12 may form mode competition. Different multi-mode interference conditions result in different coupling conditions between the multi-mode transmission region 12 and the micro-ring waveguide 2. Thus, the transmission spectrum of the micro-ring resonator can be controlled to form a Fano resonance line-shape transmission spectrum. FIG. 13 is a schematic diagram illustrating that optical signals are transmitted in a multi-mode transmission region according to an embodiment of the present application. FIG. 13 shows the lateral intensity distribution of electromagnetic radiation of a predetermined wavelength in the multi-mode transmission region 12 along the length L and the width W.

According to the technical solution provided by this embodiment, the multi-mode straight waveguide 1 disposed in the coupling region is set as a multi-mode transmission region, and the portion of the multi-mode straight waveguide 1 disposed in the coupling region S0 is widened and lengthened, that is, the multi-mode transmission region includes a straight waveguide transmission portion and a side waveguide transmission portion. This structure preserves the compactness of the micro-ring resonator and enables the regulation and control of the micro-ring resonance line-shape, thereby enhancing the performance of the micro-ring. In terms of techniques, this characteristic dimension can be obtained through one-step etching with the micro-ring, which is simple. The multi-mode transmission region may divide an optical signal into at least two optical signals so that mode competition occurs in the optical signals in the coupling region S0. Different multi-mode interference conditions are obtained by the control of the characteristic dimensions of the multi-mode transmission region, such as the length and width. Different multi-mode interference conditions result in different coupling conditions between the multi-mode straight waveguide 1 and the micro-ring waveguide 2. Thus, the transmission spectrum of the micro-ring resonator can be controlled to form a Fano resonance line-shape transmission spectrum, making the micro-ring resonator a Fano-type micro-ring resonator. In this embodiment, the portion of the multi-mode straight waveguide 1 disposed in the coupling region S0 may be widened and lengthened. It is in no need to form, for example, a grating reflection structure and air holes in the single-mode straight waveguide by etching a small-sized single-mode straight waveguide to form a micro-ring resonator with a Fano resonance line-shape transmission spectrum, which simplifies the preparation technique and reduces the cost. Thus, it is suitable for large-scale production. Moreover, the principle of the micro-ring resonator provided by embodiments of the present application is different from that of the Fano-type micro-ring resonator formed in a manner where, for example, a grating reflection structure and air holes are formed in a single-mode straight waveguide. The Fano-type micro-ring resonator formed in a manner where, for example, a grating reflection structure and air holes are formed in a single-mode straight waveguide in the related art is formed by the formation of a Fabry-Perot resonant cavity or a Bragg grating reflection-type structure in the single-mode straight waveguide.

In an embodiment, with reference to FIGS. 2 and 3, the side waveguide transmission portion 121 is disposed at one side of the straight waveguide transmission portion 120 away from the micro-ring waveguide 2.

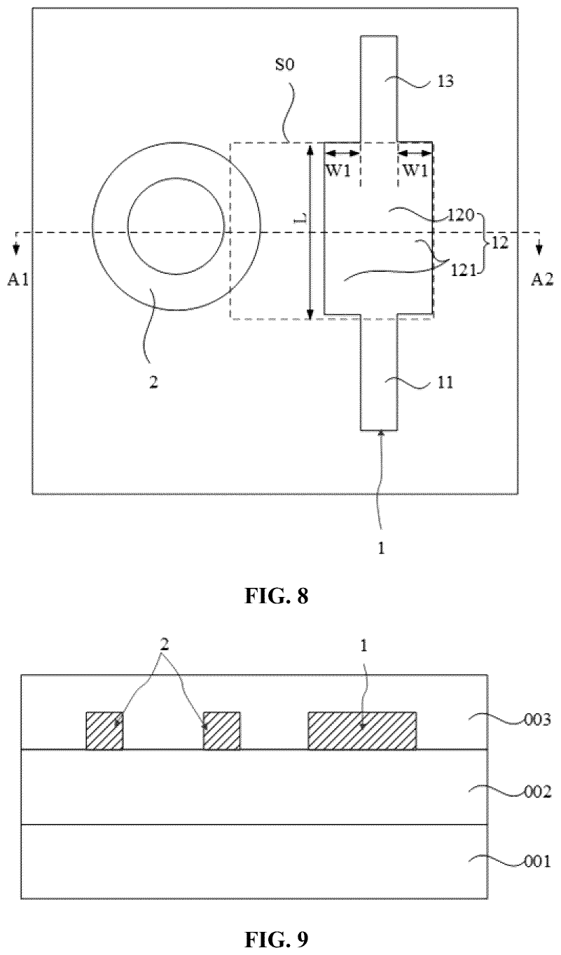

In an embodiment, with reference to FIGS. 8 and 9, the side waveguide transmission portion 121 is disposed at one side of the straight waveguide transmission portion 120 adjacent to the micro-ring waveguide 2 and at one side of the straight waveguide transmission portion 120 facing away from the micro-ring waveguide 2 separately; the side waveguide transmission portion 121 is symmetrically disposed with respect to the straight waveguide transmission portion 120.

In an embodiment, the sectional pattern of the side waveguide transmission portion 121 disposed at one side of the straight waveguide transmission portion 120 includes a rectangular shape.

In an embodiment, different multi-mode interference conditions are obtained by the control of the characteristic dimensions of the multi-mode transmission region 12, such as the length L and width W. Different multi-mode interference conditions result in different coupling conditions between the multi-mode straight waveguide 1 and the micro-ring waveguide 2. Thus, the transmission spectrum of the micro-ring resonator can be controlled to form a Fano resonance line-shape transmission spectrum, making the micro-ring resonator a Fano-type micro-ring resonator. Since the multi-mode transmission region 12 includes a straight waveguide transmission portion 120 and a side waveguide transmission portion 121 connected to each other, and the straight waveguide transmission portion 120 is disposed on the same straight line as the single-mode input terminal 11 and the single-mode output terminal 13, the characteristic dimension of the entire multi-mode transmission region 12 can be controlled by the control of the characteristic dimension of the side waveguide transmission portion 121.

In an embodiment, the characteristic dimension L of a side waveguide transmission portion 121 disposed at one side of the straight waveguide transmission portion 120 and parallel to an extension direction of the multi-mode straight waveguide 1 is greater than or equal to 600 nm and less than or equal to 9 um; the characteristic dimension W1 of the side waveguide transmission portion 121 perpendicular to the extension direction of the multi-mode straight waveguide 1 is greater than or equal to 200 nm and less than or equal to 1 um. In this manner, different multi-mode interference conditions exist in the multi-mode transmission region 12. Different multi-mode interference conditions result in different coupling conditions between the multi-mode straight waveguide 1 and the micro-ring waveguide 2. Thus, the transmission spectrum of the micro-ring resonator can be controlled to form a Fano resonance line-shape transmission spectrum, making the micro-ring resonator a Fano-type micro-ring resonator. Moreover, the dimension of the side waveguide transmission portion 121 can reach a micron level, which has a low requirement for techniques and small processing errors, making it easier to mass-produce.

In an embodiment, the characteristic dimension W1 of the side waveguide transmission portion 121 disposed at one side of the straight waveguide transmission portion 120 and perpendicular to the extension direction of the multi-mode straight waveguide 1 is 450 nm, and the characteristic dimension L of the side waveguide transmission portion 121 parallel to the extension direction of the multi-mode straight waveguide 1 is any one of 1 um, 3 um, and 6 um. In an embodiment, the radius of the micro-ring waveguide 2 is about 8 um.

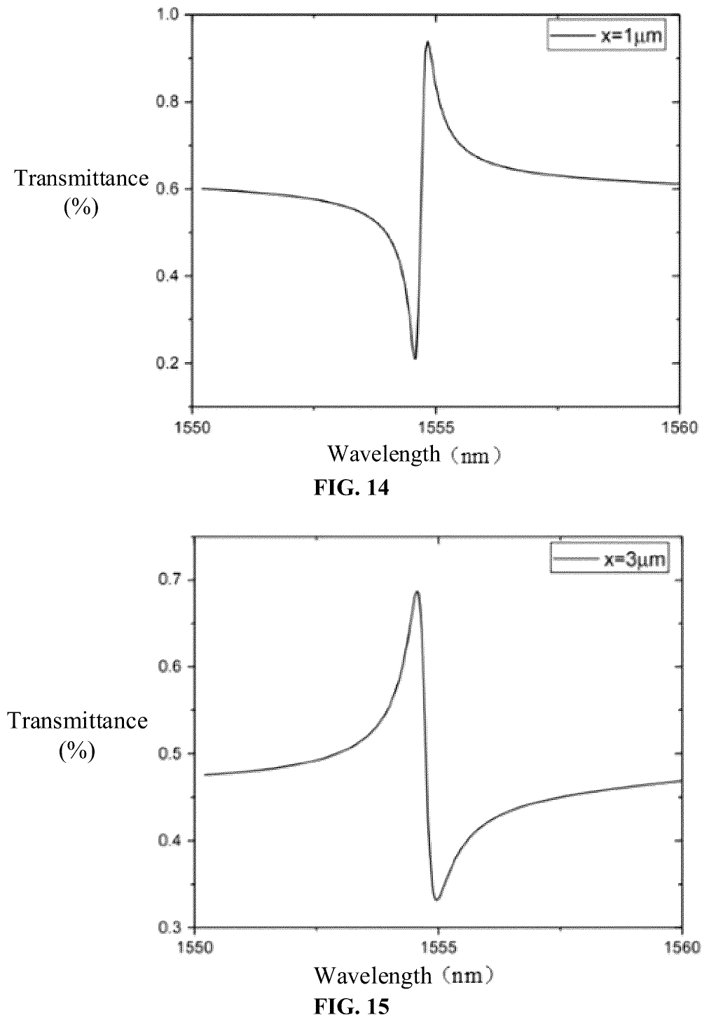

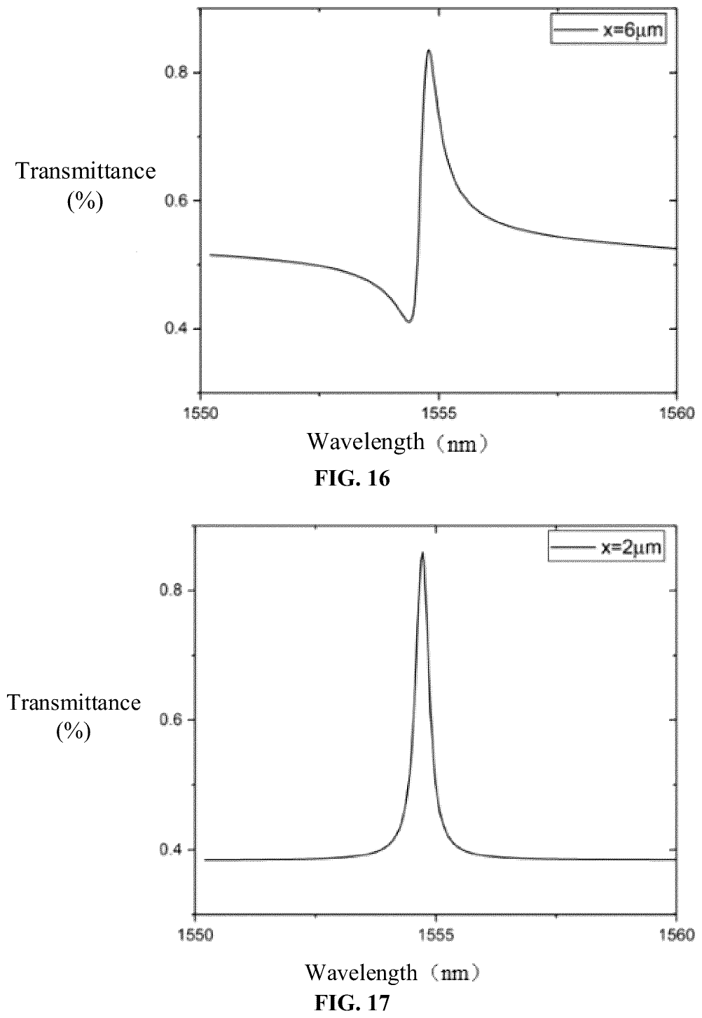

With reference to FIGS. 14 to 16, when the characteristic dimension W1 of the side waveguide transmission portion 121 perpendicular to the extension direction of the multi-mode straight waveguide 1 is 450 nm, and the characteristic dimension L of the side waveguide transmission portion 121 parallel to the extension direction of the multi-mode straight waveguide 1 includes any one of 1 um, 3 um, and 6 um, different multi-mode interference conditions exist in the multi-mode transmission region 12, and different multi-mode interference conditions result in different coupling conditions between the multi-mode straight waveguide 1 and the micro-ring waveguide 2. Thus, the transmission spectrum of the micro-ring resonator can be controlled to form a Fano resonance line-shape transmission spectrum, making the micro-ring resonator a Fano-type micro-ring resonator.

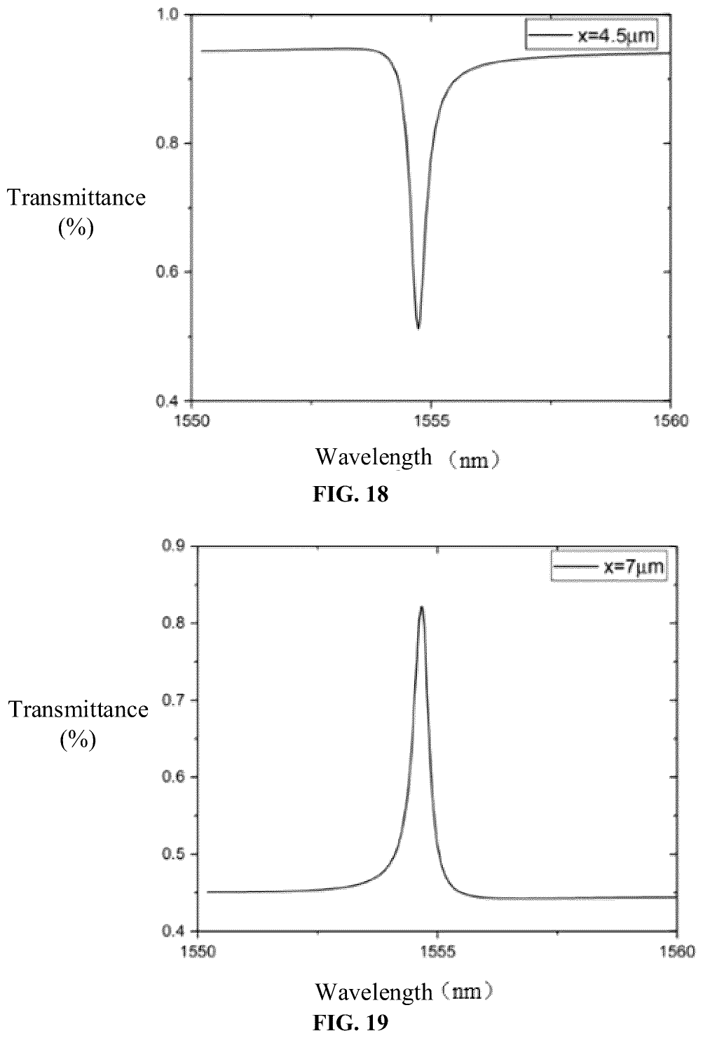

With reference to FIGS. 17 to 19, when the characteristic dimension W1 of the side waveguide transmission portion 121 perpendicular to the extension direction of the multi-mode straight waveguide 1 is 450 nm, and the characteristic dimension L of the side waveguide transmission portion 121 parallel to the extension direction of the multi-mode straight waveguide 1 includes any one of 2 um, 4.5 um, and 7 um, the transmission spectrum of the micro-ring resonator is not an asymmetric Fano resonance line-shape. In an embodiment, the radius of the micro-ring waveguide 2 is about 8 um.

In an embodiment, with reference to FIGS. 20, 22, and 24, in a direction perpendicular to the extension direction of the multi-mode straight waveguide 1, a chamfered transition portion 1a is disposed between the side waveguide transmission portion 121 and the multi-mode straight waveguide 1.

In an embodiment, the chamfered transition position la can avoid light scattering and reduce the energy loss of optical signals in the multi-mode transmission region 12, thus improving the quality factor of the micro-ring resonator.

In an embodiment, the micro-ring resonator also includes a refractive index adjustment layer and a dielectric layer, the dielectric layer is disposed on the surface of the micro-ring waveguide, and the refractive index adjustment layer is disposed on the surface of the dielectric layer facing away from the micro-ring waveguide.

In an embodiment, with reference to FIGS. 20 to 23, the outer layer 003 may be used as a dielectric layer. In an embodiment, the refractive index adjustment layer 3 causes the refractive index of the micro-ring waveguide 2 to change, thereby causing the resonant wavelength of the micro-ring waveguide 2 to change. Meanwhile, the phase difference between the multi-mode straight waveguide 1 and the micro-ring waveguide 2 changes, and the wavelength and slope of the output Fano resonance spectral line change. Thus, the Fano resonance spectrum is controlled. In an embodiment, the refractive index adjustment layer 3 may be a III-V material layer. It should be noted that in this embodiment, the orthographic projection of the refractive index adjustment layer 3 on the substrate 001 covers part or all of the orthographic projection of the micro-ring waveguide 2 on the substrate 001, and the width of the refractive index adjustment layer 3 in this embodiment may be greater than, less than, or equal to the width of the micro-ring waveguide 2.

In an embodiment, the refractive index adjustment layer includes an electrothermal layer, and the micro-ring resonator is configured to adjust the refractive index of the micro-ring waveguide by a change in the heat of the electrothermal layer.

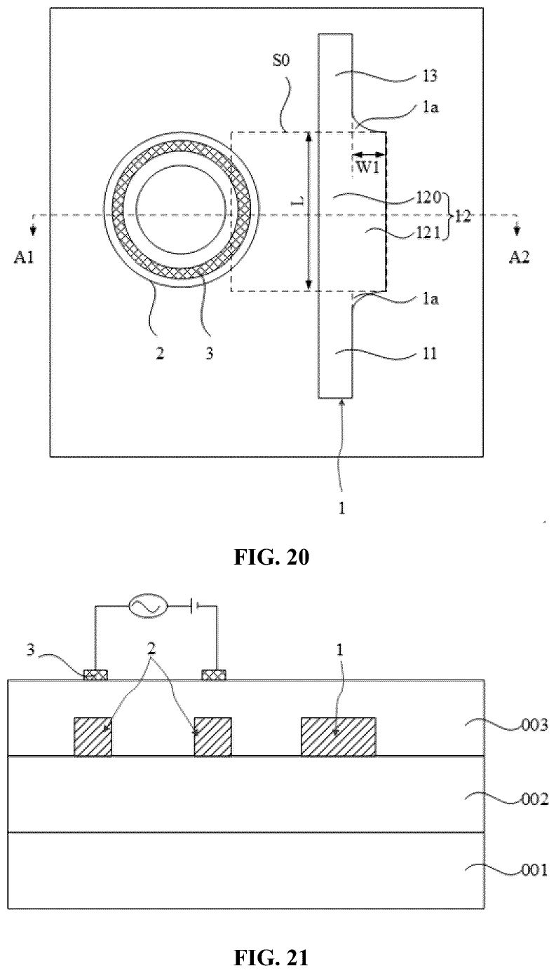

In an embodiment, with reference to FIGS. 20 and 21, the refractive index adjustment layer 3 includes an electrothermal layer, and the micro-ring resonator is configured to adjust the refractive index of the micro-ring waveguide 2 by a change in the heat of the electrothermal layer.

In an embodiment, when the electrothermal layer is used as the refractive index adjustment layer 3, heat, such as Joule heat, is generated under the action of an external voltage signal, which causes the temperature of the micro-ring waveguide 2 to change. Then, the refractive index of the micro-ring waveguide 2 changes, which in turn leads to changes in the resonant wavelength of the micro-ring waveguide. The outer cladding layer 003 is used as a dielectric layer between the refractive index adjustment layer 3 and the micro-ring waveguide 2. The configuration of the dielectric layer reduces the loss of optical signals in the micro-ring waveguide 2 during the generation of heat under the action of an external voltage signal when the electrothermal layer is used as the refractive index adjustment layer 3.

In an embodiment, the refractive index adjustment layer includes a first conductivity-type semiconductor layer, the micro-ring waveguide includes a second conductivity-type semiconductor layer, and the refractive index adjustment layer and the micro-ring waveguide constitute a MOS tube capacitor structure; the micro-ring resonator is configured to adjust the refractive index of the micro-ring waveguide by a voltage difference between the refractive index adjustment layer and the micro-ring waveguide.

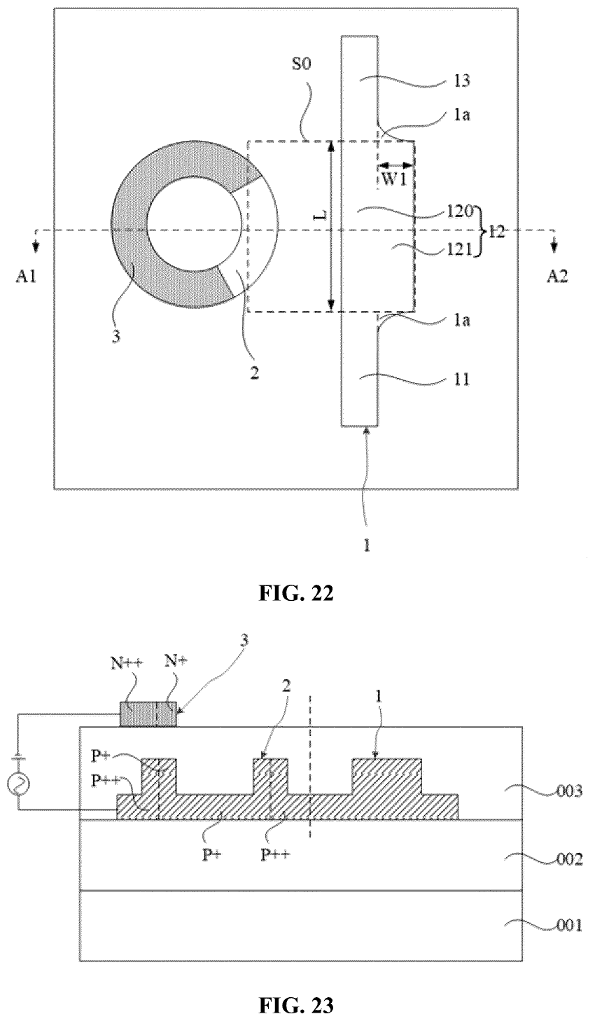

In an embodiment, with reference to FIGS. 22 and 23, the refractive index adjustment layer 3 includes a first conductivity-type semiconductor layer such as an N-type semiconductor layer, the micro-ring waveguide 2 includes a second conductivity-type semiconductor layer such as a P-type semiconductor layer, and the refractive index adjustment layer 3 and the micro-ring waveguide 2 constitute a MOS tube capacitor structure; the voltage difference between the refractive index adjustment layer 3 and the micro-ring waveguide 2 changes the local carrier concentration of the micro-ring waveguide 2, causing the refractive index of the micro-ring waveguide 2 to change and thus causing the resonant wavelength of the micro-ring waveguide 2 to change. The multi-mode straight waveguide 1 is a ridged multi-mode straight waveguide.

In an embodiment, the micro-ring waveguide includes a P-type doped region, an intrinsic region, and an N-type doped region, and the micro-ring resonator is configured to adjust the refractive index of the micro-ring waveguide by a voltage difference between the P-type doped region and the N-type doped region.

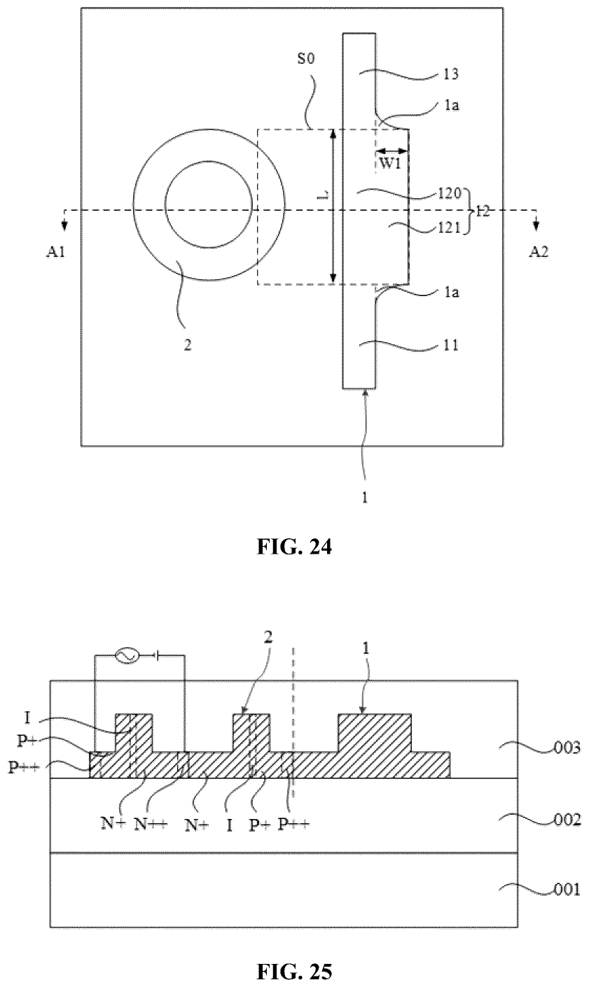

In an embodiment, with reference to FIGS. 24 and 25, the micro-ring waveguide 2 includes a P-type doped region, an intrinsic region, and an N-type doped region; the local carrier concentration of the micro-ring waveguide 2 is changed by the voltage difference between the P-type doped region and the N-type doped region, causing the refractive index of the micro-ring waveguide 2 to change and thus causing the resonant wavelength of the micro-ring waveguide 2 to change. Meanwhile, the phase difference between the multi-mode straight waveguide 1 and the micro-ring waveguide 2 changes, and the wavelength and slope of the output Fano resonance spectral line change. Thus, the Fano resonance spectrum is controlled. The multi-mode straight waveguide 1 is a ridged multi-mode straight waveguide.

An embodiment of the present application also provides an electronic device. The electronic device includes the micro-ring resonator described in any of the preceding technical solutions and any one of a filter, a sensor, a modulator, and an optical switch.

Any one of a filter, a sensor, a modulator, and an optical switch includes the micro-ring resonator. Compared with the symmetric Lorentz line-shape, the asymmetric Fano resonance line-shape has better characteristics, that is, the transmission coefficient of the spectral line changes in a wider range, and the change trend is sharper. These excellent characteristics make Fano-type resonators have more advantages in fields such as optical switches with a high on/off ratio, modulators with a high modulation depth, filters with a narrow band, and biochemical sensors with high sensitivity. When used as an optical switch, the micro-ring resonator requires a lower drive voltage and has a lower power consumption.

What is claimed is:

1. A micro-ring resonator, comprising:
a multi-mode straight waveguide; and
a micro-ring waveguide, wherein the micro-ring waveguide and the multi-mode straight waveguide are in a coupling relationship with each other;
wherein the multi-mode straight waveguide and the micro-ring waveguide have a coupling region, and a portion of the multi-mode straight waveguide disposed in the coupling region is configured to transmit at least two optical signals so that a transmission spectrum of the micro-ring resonator is a Fano resonance line-shape transmission spectrum.

2. The micro-ring resonator of claim 1, wherein the multi-mode straight waveguide comprises a single-mode input terminal, a multi-mode transmission region, and a single-mode output terminal;
the micro-ring waveguide and the multi-mode straight waveguide are in the coupling relationship with each other; and
the multi-mode transmission region is disposed in the coupling region of the multi-mode straight waveguide and the micro-ring waveguide, and the multi-mode transmission region comprises a straight waveguide transmission portion and a side waveguide transmission portion connected to each other, the straight waveguide transmission portion is disposed on a same straight line as the single-mode input terminal and the single-mode output terminal, and the side waveguide transmission portion is disposed at at least one side of the straight waveguide transmission portion.

3. The micro-ring resonator of claim 2, wherein the side waveguide transmission portion is disposed at one side of the straight waveguide transmission portion facing away from the micro-ring waveguide; or
the side waveguide transmission portion is disposed at one side of the straight waveguide transmission portion adjacent to the micro-ring waveguide and at one side of the straight waveguide transmission portion facing away from the micro-ring waveguide separately; and the side waveguide transmission portion is symmetrically disposed with respect to the straight waveguide transmission portion.

4. The micro-ring resonator of claim 2, wherein a characteristic dimension of a side waveguide transmission portion disposed at one side of the straight waveguide transmission portion and parallel to an extension direction of the multi-mode straight waveguide is greater than or equal to 600 nm and less than or equal to 9 um; and
a characteristic dimension of the side waveguide transmission portion perpendicular to the extension direction of the multi-mode straight waveguide is greater than or equal to 200 nm and less than or equal to 1 um.

5. The micro-ring resonator of claim 4, wherein the characteristic dimension of the side waveguide transmission portion perpendicular to the extension direction of the multi-mode straight waveguide is 450 nm, and the characteristic dimension of the side waveguide transmission portion parallel to the extension direction of the multi-mode straight waveguide is any one of 1 um, 3 um, and 6 um.

6. The micro-ring resonator of claim 2, wherein in a direction perpendicular to an extension direction of the multi-mode straight waveguide, a chamfered transition portion is disposed between the side waveguide transmission portion and the multi-mode straight waveguide.

7. The micro-ring resonator of claim 2, wherein the micro-ring resonator further comprising a refractive index adjustment layer and a dielectric layer, wherein the dielectric layer is disposed on a surface of the micro-ring waveguide; and
the refractive index adjustment layer is disposed on a surface of the dielectric layer facing away from the micro-ring waveguide.

8. The micro-ring resonator of claim 7, wherein the refractive index adjustment layer comprises an electrothermal layer, and the micro-ring resonator is configured to adjust refractive index of the micro-ring waveguide by a change in heat of the electrothermal layer; or
the refractive index adjustment layer comprises a first conductivity-type semiconductor layer, the micro-ring waveguide comprises a second conductivity-type semiconductor layer, and the refractive index adjustment layer and the micro-ring waveguide constitute a MOS tube capacitor structure; and the micro-ring resonator is configured to adjust refractive index of the micro-ring waveguide by a voltage difference between the refractive index adjustment layer and the micro-ring waveguide.

9. The micro-ring resonator of claim 2, wherein the micro-ring waveguide comprises a P-type doped region, an intrinsic region, and an N-type doped region, and the micro-ring resonator is configured to adjust refractive index of the micro-ring waveguide by a voltage difference between the P-type doped region and the N-type doped region.

10. An electronic device, comprising a micro-ring resonator and any one of a filter, a sensor, a modulator, and an optical switch;
wherein the micro-ring resonator comprises:
a multi-mode straight waveguide; and
a micro-ring waveguide, wherein the micro-ring waveguide and the multi-mode straight waveguide are in a coupling relationship with each other;
wherein the multi-mode straight waveguide and the micro-ring waveguide have a coupling region, and a portion of the multi-mode straight waveguide disposed in the coupling region is configured to transmit at least two optical signals so that a transmission spectrum of the micro-ring resonator is a Fano resonance line-shape transmission spectrum.

11. The electronic device of claim 10, wherein the multi-mode straight waveguide comprises a single-mode input terminal, a multi-mode transmission region, and a single-mode output terminal;
the micro-ring waveguide and the multi-mode straight waveguide are in the coupling relationship with each other; and
the multi-mode transmission region is disposed in the coupling region of the multi-mode straight waveguide and the micro-ring waveguide, and the multi-mode transmission region comprises a straight waveguide transmission portion and a side waveguide transmission portion connected to each other, the straight waveguide transmission portion is disposed on a same straight line as the single-mode input terminal and the single-mode output terminal, and the side waveguide transmission portion is disposed at at least one side of the straight waveguide transmission portion.

12. The electronic device of claim 11, wherein the side waveguide transmission portion is disposed at one side of the straight waveguide transmission portion facing away from the micro-ring waveguide; or
the side waveguide transmission portion is disposed at one side of the straight waveguide transmission portion adjacent to the micro-ring waveguide and at one side of the straight waveguide transmission portion facing away from the micro-ring waveguide separately; and the side waveguide transmission portion is symmetrically disposed with respect to the straight waveguide transmission portion.

13. The electronic device of claim 11, wherein a characteristic dimension of a side waveguide transmission portion disposed at one side of the straight waveguide transmission portion and parallel to an extension direction of the multi-mode straight waveguide is greater than or equal to 600 nm and less than or equal to 9 um; and
a characteristic dimension of the side waveguide transmission portion perpendicular to the extension direction of the multi-mode straight waveguide is greater than or equal to 200 nm and less than or equal to 1 um.

14. The electronic device of claim 13, wherein the characteristic dimension of the side waveguide transmission portion perpendicular to the extension direction of the multi-mode straight waveguide is 450 nm, and the characteristic dimension of the side waveguide transmission portion parallel to the extension direction of the multi-mode straight waveguide is any one of 1 um, 3 um, and 6 um.

15. The micro-ring resonator of claim 11, wherein in a direction perpendicular to an extension direction of the multi-mode straight waveguide, a chamfered transition portion is disposed between the side waveguide transmission portion and the multi-mode straight waveguide.

16. The micro-ring resonator of claim 11, wherein the micro-ring resonator further comprising a refractive index adjustment layer and a dielectric layer, wherein the dielectric layer is disposed on a surface of the micro-ring waveguide; and
the refractive index adjustment layer is disposed on a surface of the dielectric layer facing away from the micro-ring waveguide.

17. The micro-ring resonator of claim 16, wherein the refractive index adjustment layer comprises an electrothermal layer, and the micro-ring resonator is configured to adjust refractive index of the micro-ring waveguide by a change in heat of the electrothermal layer; or
the refractive index adjustment layer comprises a first conductivity-type semiconductor layer, the micro-ring waveguide comprises a second conductivity-type semiconductor layer, and the refractive index adjustment layer and the micro-ring waveguide constitute a MOS tube capacitor structure; and the micro-ring resonator is configured to adjust refractive index of the micro-ring waveguide by a voltage difference between the refractive index adjustment layer and the micro-ring waveguide.

18. The micro-ring resonator of claim 11, wherein the micro-ring waveguide comprises a P-type doped region, an intrinsic region, and an N-type doped region, and the micro-ring resonator is configured to adjust refractive index of the micro-ring waveguide by a voltage difference between the P-type doped region and the N-type doped region.
